(19) United States
(12) Patent Application Publication
(10) Pub. No.: US 2020/0268195 A1
(43) Pub. Date: Aug. 27, 2020

(54) ASSEMBLY ADAPTED TO BE EMBEDDED IN A MIXING HEAD OF A FOOD OR BEVERAGE PREPARATION MACHINE

(71) Applicant: SOCIETE DES PRODUITS NESTLES S.A, Vevey (CH)

(72) Inventor: Vincent Rognon, Orbe (CH)

(21) Appl. No.: 16/763,668

(22) PCT Filed: Nov. 12, 2018
(86) PCT No.: PCT/EP2018/080887

§ 371 Date: May 13, 2020

(30) Foreign Application Priority Data
Nov. 14, 2017 (EP) 17201555.4

(51) Int. Cl. A47J 31/46; A47J 31/40

(52) U.S. Cl. CPC A47J 31/46; A47J 31/407

(57) ABSTRACT

The invention relates to a food or beverage preparation assembly comprising: —a container holder (11) adapted for receiving a container and comprising an outlet port (15), and—an inlet port (14) for connecting the assembly to a source (3) of a fluid mixing ingredient. Between the inlet port (14) and the container holder (11), the assembly comprises a chamber (16) having a variable volume, such that an alternating increase and decrease in the volume of the chamber (16) may be provided for pumping mixing ingredient from the source of mixing ingredient to the inlet port (14) of the assembly, and for generating a flow of mixing ingredient through the chamber (16) having a variable volume and through the container holder (11). The invention also relates to a food or beverage preparation machine such an assembly embedded in a mixing head.

### FIELD OF THE INVENTION

The present invention concerns an assembly for food or beverage preparation. The assembly is designed for connection to a non-pressurized ingredient source, such as a water source, to be mixed under pressure with the content of container for preparing said food or beverage.

### BACKGROUND OF THE INVENTION

In the field of food or beverage preparation, it is known to use single-serve capsules for mixing a precursor ingredient contained in said capsule, with a mixing ingredient fed from a pressurized source contained in a food or beverage preparation machine.

Generally, food or beverage preparation machines are well known in the food science and consumer goods area. Such machines allow a consumer to prepare at home a given type of food or beverage, for instance a coffee-based beverage, e.g. an espresso or a brew-like coffee cup, or other types of beverages like chocolate, teas, soups and the like.

Today, most beverage preparation machines for in-home beverage preparation comprise a system made of a machine which can accommodate portioned ingredients for the preparation of the beverage. Such portions can be soft pods or pads, or sachets, but more and more systems use semi-rigid or rigid portions such as rigid pods or capsules.

The machine comprises a receptacle or cavity of a capsule holder for accommodating said capsule and a fluid injection system for injecting a fluid, preferably water, under pressure into the capsule. Water injected under pressure into the capsule, for the preparation of a coffee beverage according to the present invention, is preferably hot, that is to say at a temperature above 70° C. However, in some particular instances, it might also be at ambient temperature, or even chilled. The pressure (relative to atmospheric pressure) inside the container/capsule chamber during extraction and/or dissolution of the capsule contents, until the capsule opens, increases up to typically about 1 to about 8 bar for dissolution products and about 2 to about 12 bar for extraction of ground roast coffee. Such a preparation process greatly differs from the so-called “brewing” process of beverage preparation—particularly for tea and coffee, in that brewing involves a long time of infusion of the ingredient by a fluid (e.g. hot water), whereas the beverage preparation process allows a consumer to prepare a beverage, for instance coffee, within a few seconds.

The principle of extracting and/or dissolving the contents of a closed capsule under pressure is known, and consists typically of inserting the capsule into a receptacle or cavity of a machine, injecting a quantity of pressurized water into the capsule, generally after piercing a face of the capsule with a piercing injection element such as a fluid injection needle mounted on the machine, so as to create a pressurized environment inside the capsule either to extract the substance or dissolve it, and then release the extracted substance or the dissolved substance through the capsule.

Machines allowing the application of this principle have already been described for example in patents CH 605 293 and EP 242 556. According to these documents, the machine comprises a receptacle or cavity for the capsule and a perforation and injection element made in the form of a hollow needle which opens the top portion of the capsule, and forms the water inlet channel into the capsule.

The machine further comprises a fluid tank—in most cases this fluid is water—for storing the fluid that is used to dissolve and/or infuse and/or extract under pressure the ingredient(s) contained in the capsule. The machine comprises a heating element such as a boiler or a heat exchanger, which is able to warm up the water used therein to working temperatures (conventionally temperatures up to 80-90° C.). Finally, the machine comprises a pump element for passing the water from the tank to the capsule, optionally though the heating element.

When the beverage to be prepared is coffee, one advantageous way to prepare the coffee is to provide the consumer with a capsule containing ground roast coffee, which is to be extracted with hot water injected therein.

Capsules have been developed for such an application of food preparation, and in particular for beverage preparation, which are described and claimed in applicant's European patent EP 1784344 B1, or in European patent application EP 2062831.

In short, such capsules comprise typically:
a hollow body and an injection wall which is impermeable to liquids and to air and which is attached to the body and adapted to be punctured by e.g. an injection needle of the machine,
a chamber containing a bed of ground roast coffee to be extracted, or a soluble ingredient or mix of soluble ingredients,
an aluminium membrane disposed at the bottom end of the capsule, closing the capsule, for retaining the internal pressure in the chamber.

The aluminium membrane is designed for being pierced with piercing means that are either integral with the capsule, or located outside of said capsule, for example within a capsule holder of the machine.

In many food and beverage preparation systems, several types of containers (such as capsules) can be used with the same machine. Some capsules can be used for infusion of a stationery precursor ingredient (e.g. ground roast coffee) through which the mixing ingredient (e.g. hot water) flows. Some other capsules may also contain a soluble precursor ingredient, such as a soluble milk or chocolate powder, which is dissolved by mixing with a mixing ingredient such as hot water. In known food and beverage systems, the food or beverage preparation is equipped with a pump that withdraws the mixing fluid (typically water) from the machine reservoir and displaces it through the fluid pipe system of the machine towards the capsule wherein said water is injected.

Thus, according to the standard known design of food or beverage preparation machines using such capsules, a pump is provided in the machine for pumping the mixing ingredient (generally water) from a reservoir to a mixing head where the mixing ingredient is mixed with at least one precursor ingredient contained in the capsule (or other container). This may cause scaling issues of the pump and other parts of the machine between the pump and the mixing head. The machines may be noisy and the parts between the pump and the mixing head may be subject to vibration.

To obviate these problems, PCT application WO2015/004259 discloses a container for food or beverage preparation, e.g. a capsule, comprising a compartment containing a precursor ingredient such as roast coffee forming the food or beverage preparation when it is mixed with a mixing ingredient such as hot water. The container comprises built-in pump means made of an elastically deformable chamber that is able to expand and retract for pumping the mixing ingredient. This container makes it possible to simplify the design of the food or beverage machine adapted to use the disclosed container because the high pressure is created directly in the container where the precursor ingredient is mixed with the mixing ingredient. This also makes it possible to eliminate the noisy solenoid pump that is generally present in the body of the food or beverage preparation machine, and to limit the vibrations generally created in the pipe system between the pump and the extraction head where the capsule is placed for food or beverage preparation.

For the sake of clarity, a “pump” is defined within the meaning of the present invention as “a device that converts mechanical energy into fluid energy by any of various technologies, typically by suction or compression, in order to move water, air, or other fluids into, though, or out of a system”. Typically, in most known food or beverage preparation systems, the pump contained in the machine is actuated by an electric motor, and converts mechanical energy brought by said electric motor, into fluid energy that conveys water from the machine reservoir to the capsule, as described above. The pumps used in most known food or beverage preparation machines are typically piston pumps using solenoid technology. The pump disclosed in WO2015/004259 comprises pumping means formed of a chamber that is deformable via an external mechanical actuator, so that its volume changes, and external actuation means. The expansion and retraction of the chamber causes the fluid to flow in the chamber via an inlet, and then flow outside the chamber via an outlet.

The formation of pumping means and of a pump requires a deformable chamber to be created. Such deformable chamber has at least one deformable wall, made of an elastically stretchable or deformable material. Various stretchable materials may be used, but the formation of a deformable wall causes a high increase in the capsule cost. The expansion and retraction of the deformable chamber is limited by the elasticity limit of the stretchable or deformable wall. In addition, the elastically stretchable or deformable wall has to be connected to a mechanical actuator by connection means linked to said elastically stretchable or deformable wall. This, and the fact that the container comprises at least two chambers, namely the compartment containing a precursor ingredient and the deformable volume, leads to a complex design of the container.

It is therefore an objective of the present invention to provide a food or beverage preparation assembly for forming a food or beverage preparation system with an adapted food or beverage container that obviates the drawbacks mentioned above.

### SUMMARY OF THE INVENTION

According to the invention, there is provided a food or beverage preparation assembly adapted to be embedded in a mixing head of a food or beverage preparation machine. The assembly comprises a container holder adapted for receiving a food or beverage precursor ingredient container, said container holder comprising an outlet port. The assembly also comprises an inlet port for connecting the assembly to a source of a fluid mixing ingredient.

The assembly comprises, between its inlet port and the container holder, a chamber having a variable volume, such that an alternating increase and decrease in the volume of the chamber may be provided for pumping mixing ingredient from the source of mixing ingredient to the inlet port of the assembly, and for generating a flow of mixing ingredient through the chamber having a variable volume and through the container holder. Consequently, when a source of mixing ingredient is connected to the inlet port and a container is received in the container holder, food or beverage product is prepared by mixing the precursor ingredient contained in the container and mixing fluid, and the food or beverage product is expelled through the outlet port.

The chamber having a variable volume that is comprised in the mixing head forms pumping means used to generate the flow of the fluid, e.g. water, in the food or beverage preparation assembly. When the pumping means are actuated, the volume of the chamber alternately increases and decreases, causing a pumping effect thanks to the adapted configuration of the mixing head.

The location of pumping means inside the mixing head has several advantages. The design of the assembly may be simplified compared to known machine designs. The manufacturing cost of the machine can be reduced. Simpler and lighter machines can be obtained. Furthermore, because high pressure is produced only inside the mixing head, the other parts do not have to sustain high pressure, and can be made of standard material and with a simple design.

Lastly, existing capsules can be used in the food or beverage machine, without being redesigned.

The chamber may be defined in a cylinder between an end wall of the cylinder and the top face of a piston, and the piston may be translated in the cylinder to increase or decrease the volume of the chamber.

According to a first embodiment, the inlet port may be comprised in the cylinder end wall, and the piston may be formed by the container holder or rigidly linked to the container holder. The piston may for example be formed on an upper wall of the container holder.

According to a second embodiment, the inlet port is comprised in the piston and the cylinder end wall is formed by the container holder.

In the first or second embodiment, the cylinder may be fixed and the piston mobile. Alternatively, the piston may be fixed and the cylinder mobile.

The piston may comprise a longitudinal channel through which the fluid mixing ingredient can flow.

The piston may comprise a peripheral groove and a seal may be installed in said peripheral groove.

According to a third embodiment, the chamber having a variable volume comprises an elastically deformable wall.

In all embodiments, the inlet port may comprise a one-way valve adapted to let fluid enter the chamber having a variable volume.

The container holder may comprise the inlet port which is situated in a central position of a bottom wall of said container holder.

The assembly may comprise a mechanical actuator adapted to successively and alternately increase and reduce the volume of the chamber. In particular, the mechanical actuator may comprise an electrically driven motor, a piezo electric actuator, or a manual actuator.

The invention also relates to a food or beverage preparation machine comprising a mixing head comprising a food or beverage preparation assembly as previously described.

### BRIEF DESCRIPTION OF THE DRAWINGS

Other particularities and advantages of the invention will also emerge from the following description.

In the accompanying drawings, given by way of non-limiting examples:

FIG. 1 is a perspective view of a food or beverage machine;

FIG. 2 is a schematic perspective view of a first embodiment of a food or beverage preparation assembly according to the invention;

FIG. 3 is a cross-section view of the assembly of FIG. 2 in a first position;

FIG. 4 is cross-section view of the assembly of FIG. 2 in a second position;

FIG. 5 is a cross-section view of a system comprising an assembly according to the first embodiment of the invention and a food or beverage capsule;

FIG. 6 is an example embodiment of a food or beverage capsule that can be used in an assembly according to the invention;

FIG. 7 is a cross-section view of a second embodiment of a food or beverage assembly according to the invention;

FIG. 8 is a cross-section view of a third embodiment of a food or beverage assembly according to the invention.

### DETAILED DESCRIPTION OF THE INVENTION

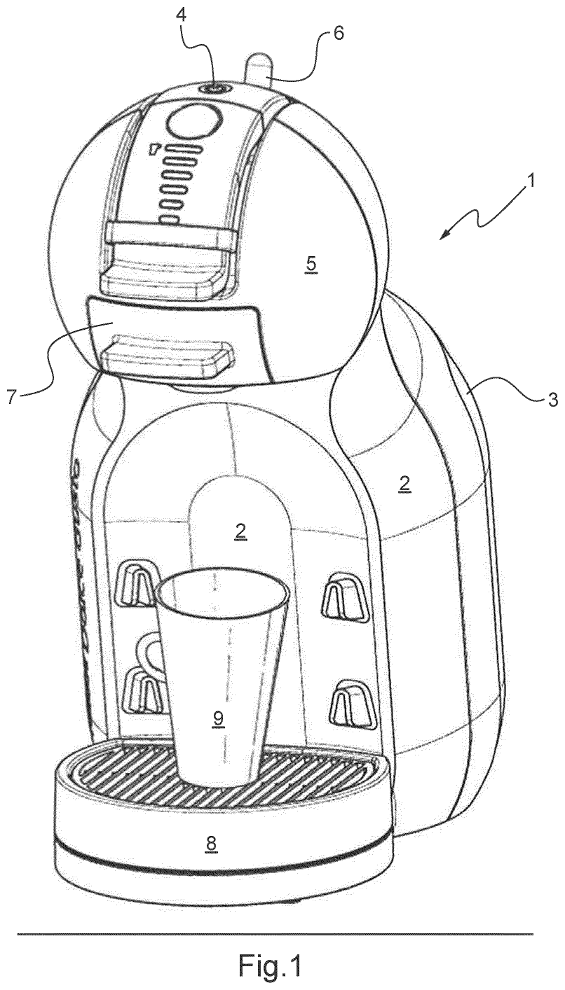

As shown in FIG. 1, the machine 1 comprises a machine body 2, a reservoir 3 adapted for containing a mixing ingredient, for instance water. The reservoir 3 is removable from the machine body 2 for refill.

In the described embodiment of the machine, water is provided from the reservoir 3 and used as mixing ingredient for food or beverage preparation.

Such a limitation should not be taken as a limitation of the scope of the invention. In alternative embodiments, sources other than sources using a reservoir may be used, such as a connection to a water distribution network. Fluid mixing ingredients other than water can be used.

The machine body 2 comprises an on/off push button 4. The machine 1 further comprises a mixing head 5. In the represented embodiment, the head 5 comprises a water temperature selector for hot or cold water taking the form of two buttons 6 (one for selecting a hot beverage, the other for cold), and a door 7 giving access to a container holder, namely a capsule holder (not visible in FIG. 1). The machine 1 further comprises a cup tray 8, for holding a cup 9 under the extraction head. The machine further comprises a control panel 10 comprising a selector wheel for selecting for instance the volume of beverage to be dispensed, as well as a screen, wherein data about the beverage preparation settings are represented.

The machine 1 comprises a fluid pipe system that conveys the water held in the reservoir 3 towards the mixing head 5 where it is injected inside a food or beverage container such as a capsule that has been loaded inside the capsule holder. The capsule holder thus has an inner shape adapted to receive a capsule.

In the rest of the present description, and for simplification purposes, it will be considered that the container of the invention is a beverage container, and more precisely a single-serve beverage capsule. Again, this should not be taken as a limitation of the scope of the invention. The container of the invention can be of a type other than a capsule, for instance it can be a soft pad, a pod, a sachet, a rigid or semi-rigid cartridge, or a combination thereof.

The container holder may thus have several configurations adapted to the type of container that it is intended to receive. The container holder may be a capsule holder, having an inner shape substantially corresponding to the external shape of a capsule. The container holder may generally have a hollow shape corresponding to the external shape of the container it is designed for. In other embodiments, the container holder may have an inner volume larger than the container. For example, the container holder may be configured to engage only a part or parts of the container such as a flange. The container holder may for example comprise a slot where a flange of the container may be inserted and grasped. The container holder may have other configurations adapted to receive and hold or grasp a certain type of container.

The term “mixing” in “mixing head” is used to describe the bringing of fluid mixing ingredient such as water into contact with at least one food or beverage precursor contained in the food or beverage container, e.g. the capsule. The food or beverage precursor may be solubilised into the fluid mixing ingredient or aroma may be extracted from the food or beverage precursor, for example when it is roast coffee powder. The precursor ingredient contained in the container of the invention can be of any type for preparing a food or a beverage product. The principle of the invention can be applied to any suitable container for preparation of an edible preparation, be it a beverage or a semi-solid or solid food, for example such as but not limited to: ice cream, potage, smoothies, cooking dough, soup comprising solid elements such as croutons, or even fully solid food such as pastry.

Mixing thus generally describes a solubilisation or an extraction for obtaining an edible product.

Optionally, the mixing fluid can be conveyed through a heating or chilling element of the machine that is located between the reservoir 3 and the mixing head 5.

In the invention, the water or other mixing ingredient is delivered to the mixing head by a non-pressurized source.

Generally, in the context of the present invention, by “non-pressurized” source of mixing ingredient (e.g. water) it is meant that the source does not comprise an element able to generate a pressure to force the flow of mixing ingredient towards the mixing head 5. The relative pressure of mixing ingredient within the fluid system of the machine before the mixing head is about equal to atmospheric pressure. However, the mixing ingredient is preferably brought to a relative pressure inside the mixing head and the capsule, which is comprised between 1 and 20, more preferably 2 to 15 bar.

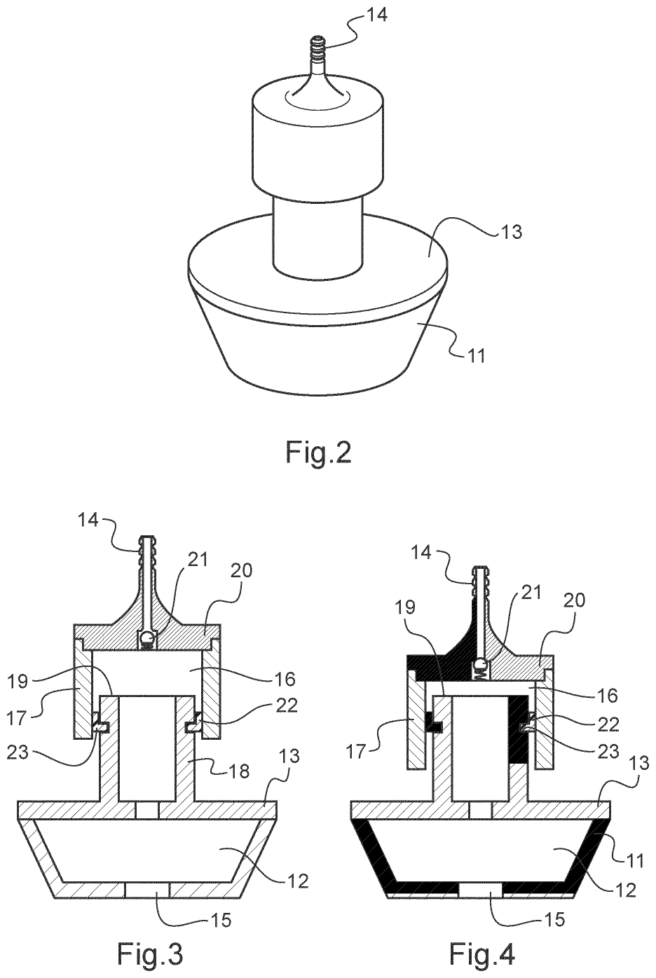

FIG. 2 is a perspective view of a first embodiment of a food or beverage preparation assembly according to the invention. This assembly is intended to be embedded in the mixing head of a beverage preparation machine as shown in FIG. 1.

The assembly comprises a container holder 11 defining an inner volume 12 having a shape adapted to receive a food or beverage container such as a capsule. The top of the capsule holder 11 is closed by an upper wall 13 that is fixed to said capsule holder. According to alternative embodiments of the invention, a capsule can be inserted into the capsule holder in various ways. The capsule holder 11 may be detached from the upper wall 13 for capsule insertion. The upper face of the capsule holder may be disengaged from the upper wall 13 by a rotation movement, provided that the capsule holder 11 and the upper wall 13 are hingedly mounted, or a translation movement.

The assembly comprises an inlet port 14 to be connected to a source of mixing fluid such as the reservoir 3 and corresponding fluid pipes of the machine of FIG. 1. An outlet port 15 of the assembly is provided at the bottom of the capsule holder 11.

Assembly comprises a pumping means for pumping mixing ingredient from the source of mixing ingredient to the inlet port. The pumping means are also adapted to pressurize the mixing ingredient into the assembly, and notably into a capsule loaded in the capsule holder 11. The pumping means comprises a chamber 16 having a variable volume. This chamber 16 may be formed according to various embodiments. This chamber 16 is situated between the inlet of the assembly, which opens into the chamber 16, and the inner volume 12 capsule holder 11.

According to a first embodiment of the invention shown in FIG. 3, the chamber is defined in a cylinder 17 into which the inlet port 14 opens. A piston 18 may slide into the cylinder 17. The movement of the piston into the cylinder increases or decreases the volume of the chamber 16 that is defined between the peripheral wall of the cylinder 17, a top face 19 of the piston 18 and an end wall 20 of the cylinder 17.

In FIG. 3, the assembly is shown in an expanded position, wherein the chamber 16 has a maximum volume.

In the first embodiment of the invention shown in FIG. 3, the piston 18 is formed by or rigidly fixed to the upper wall 13. The capsule holder 11 which is so fixed to the piston 18 moves with the piston 18, or may be seen as a part of the piston 18.

FIG. 4 shows the assembly of FIG. 3 in a retracted position, wherein the chamber 16 has a reduced volume. In this position, the top face 19 of the piston 18 is in the vicinity of the end wall 20 of the cylinder 17.

The relative movement of the piston 18 and the cylinder 17 causes the volume of the chamber to increase when the top face 19 of the piston 18 moves away from the end wall 20 and decreases when the top face 19 of the piston 18 approaches the end wall 20.

When the volume of the chamber 16 increases, mixing ingredient is sucked from source of mixing ingredient into the chamber 16 via the inlet port 14. When the volume of the chamber 16 decreases, the mixing ingredient contained in the chamber 16 is expelled out of said chamber 16 into the inner volume 12 of the capsule holder 11, and consequently into a capsule contained in the capsule holder. To avoid the mixing ingredient flowing back to the source a one-way valve 21 is provided at the inlet port 14.

The one-way valve 21 may be for example a duckbill valve, a ball valve, an umbrella valve, or a combination thereof.

To create the suction effect when the volume of the chamber 16 increases, a similar one-way valve may be provided at the outlet port. However, and as in the illustrated examples, the pressure drop generated in a capsule or more generally in the food or beverage container is used to generate a pressure drop causing the suction effect.

To provide a fluid tight interface between the piston 18 and the cylinder 17, a seal 22 is provided. The seal 22 may be arranged in a peripheral groove 23 of the piston 18.

The seal 22 may be a grooved-ring-type seal with metal pre-tension spring. Such a seal comprises a metal frame that radially pushes an external rubber part. The seal has to prevent leakage of the mixing ingredient such as water at the highest pressure and temperature that are reached in the chamber 16.

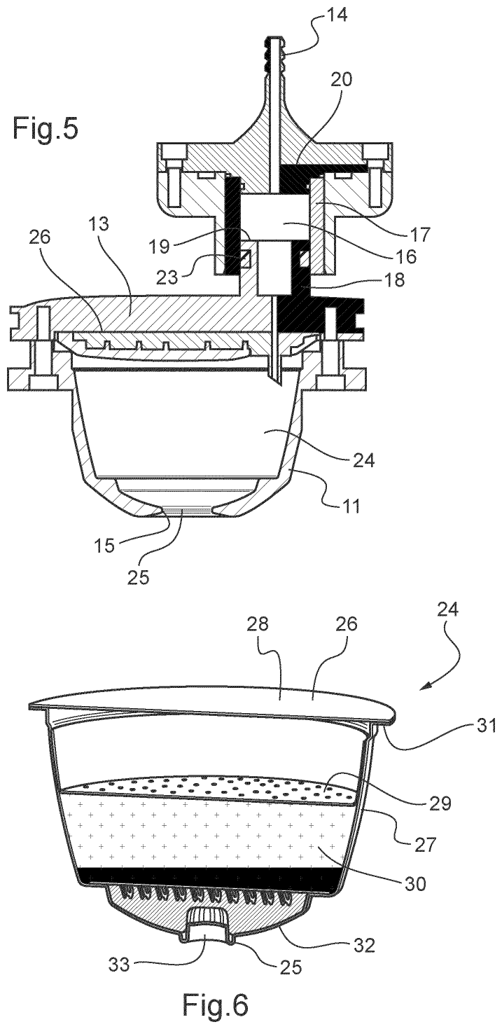

FIG. 5 shows a system comprising an assembly according to the first embodiment of the invention whose principle has been describe with reference to FIGS. 2 to 4, and a food or beverage capsule 24. A capsule 24 example is described in more detail with reference to FIG. 6. The capsule is received and maintained in the capsule holder 11. The general external shape of the capsule corresponds to the shape of the cavity defining the inner volume 12 of the capsule holder 11. For example, the capsule may have a cylindrical or frusto-conical general shape. This provides safe positioning of the capsule in the capsule holder. In the represented embodiment, the capsule comprises a bottom protrusion 25 that is a capsule outlet and which is inserted into the outlet port 15.

The capsule 24 may comprise a peripheral flange at its top, which is received into a corresponding bore formed at the top of the cavity defining the inner volume 12. The top face 26 of the capsule 24 is sealingly pressed at its periphery (e.g. by its flange) against the upper wall 13, so that water entering into the capsule holder inner volume 12 and into the capsule 24 through an injection needle must flow through the capsule 24 to reach the outlet port 15.

In the represented embodiment, the one-way valve is provided before the inlet port 14, in the fluid pipes that connect the inlet port 14 to a reservoir of mixing ingredient.

As represented in FIG. 5, the parts used in the assembly are massive parts dimensioned to resist the high pressure generated in the chamber 16. One of the main advantages of the invention is that the rest of the machine, and in particular the reservoir and the parts (pipes, optional heaters or coolers, etc.) between the reservoir and the inlet port 14 do not have to sustain high pressures. These parts can be made using standard materials that are cost effective and that do not have superior mechanical properties.

An example embodiment of a beverage capsule 24 is illustrated in FIG. 6. Although the invention is described with reference to an example capsule represented in FIG. 6, it should be noted that the invention may be used with many other types of food or beverage container. The container may for example be made of any suitable type of impermeable material such plastic, coated paper, coated cardboard, metal or alloy, glass, synthetic or natural rubber or elastomer, or a combination thereof. Preferably, materials will be chosen from cost-effective and ecologic material, having barrier properties, preferably at least against moisture and oxygen.

The capsule 24 of FIG. 6 comprises a capsule body made of capsule walls 27, which are made of a rigid or semi-rigid thermoplastic such as a polypropylene or polyethylene. In the represented embodiment, the capsule body walls 27 have a frusto-conical shape.

The material used can also be a biodegradable material such as a material containing cellulosic fibres, or starch for instance. The manufacturing process can be thermoforming or injection. It can also involve in-mould labelling, for instance in order to provide the capsule with specific barrier properties by using a film label with moisture and oxygen barrier properties. Such an in-mould labelling process for making a capsule is generally described in the applicant's European patent publication EP 2559636 A1.

The moisture and oxygen barrier properties of the container walls can be achieved with any kind of suitable material such as barrier thermoplastic films having single or multiple layers, or aluminium, or paper, or a combination thereof. The capsule body walls 27 comprise upper and lower openings. The upper opening of the capsule body is closed by an upper injection 28 wall forming the top face 26. The capsule 24 further comprises a rigid distributor wall 29 that is located between said injection wall 28 and a capsule interior compartment 30. The upper injection wall 28 is welded on upper peripheral edges 31 of the capsule body walls 27 as illustrated in FIG. 6.

The capsule 24 shown in FIG. 6 further comprises a bottom wall 32 having a dispensing opening 33. It further comprises a pierceable membrane 34, preferably made of aluminium, which is sealed between the lateral capsule walls and the bottom wall 32.

Between the pierceable membrane 34 and the bottom wall 32, a piercing plate 19 is provided which serves to open the pierceable membrane 34 by piercing or tearing when fluid pressure inside the capsule compartment increases, so as to let the product formed inside said compartment out towards a consumer's cup 9.

Preferably, the precursor ingredient contained in the capsule is located in the portion of the capsule compartment 30 which is between the distributor wall 29 and the bottom wall 32 of the capsule 24. However, it is also possible to enclose the same ingredient throughout the whole volume of the capsule, or alternatively, two different ingredients can be separated from one another by the rigid distributor wall 29.

The distributor wall 29 comprises through-holes. Their diameter is appropriately chosen depending on the type of ingredient contained in the capsule and on the corresponding type of product preparation. If the distributor wall comprises a single hole, the flow of fluid through said hole will create a single jet, with a powerful mixing effect. This configuration is preferably chosen in case the ingredient contained in the capsule is a soluble powder, which requires a powerful swirling movement of the water injected therein, so as to improve the dissolution of the powder with the water. Alternatively, if the ingredient contained in the capsule compartment is roast and ground coffee, the distributor wall 29 comprises a plurality of holes, distributed evenly across its surface to ensure a proper wetting of the coffee bed contained between the distributor wall 29 and the bottom wall 32 of the capsule.

The diameter of the holes is preferably less than the smallest particles of the precursor ingredient, but it is sufficient to ensure a proper flow of water through the rigid distributor wall 29. The diameter can for example be comprised typically between 10 microns and 3 mm, preferably between 100 microns and 1 mm.

The capsule, and more particularly the distributor wall 29, the precursor ingredient contained in the capsule, and the means for piercing or tearing the pierceable membrane 34, create a head loss or pressure drop that may be used in the invention instead of an outlet one way valve to generate a depression into the chamber 16 when its volume increases. This depression is used for pumping the mixing ingredient from the source of mixing ingredient.

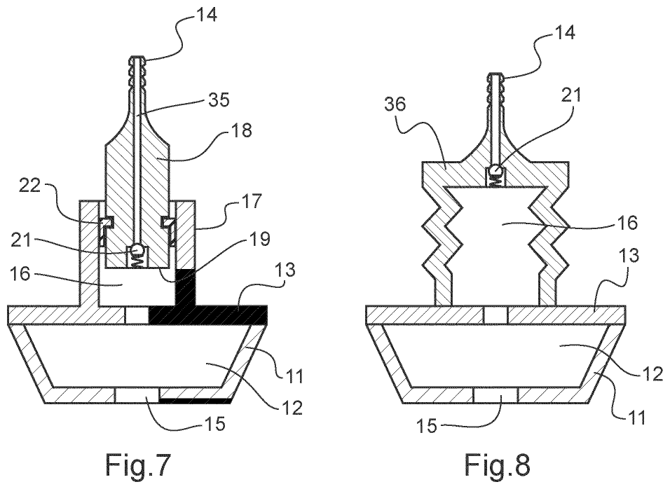

FIG. 7 illustrates a second embodiment of a food or beverage assembly according to the invention. This embodiment is similar to the first embodiment of FIGS. 2 to 5, except that the cylinder 17 is formed with or rigidly fixed to the upper wall 13. The piston 18 comprises the inlet port 14 of the assembly, and comprises the inlet one way-valve 21.

The chamber 16 having a variable volume is defined between the wall of the cylinder 17, the upper wall 13 forming an end wall of the cylinder, and the top face 19 of the piston 18. The piston 18 comprises a central longitudinal channel 35 which fluidically connects the inlet port 14 to the chamber 16.

In the first and second embodiments of FIGS. 2 to 5 and 7, a relative movement has to be generated between the piston 18 and the cylinder 17. The easiest way to generate such a relative movement is to provide a mobile capsule holder 11 while the other part is fixed (e.g. rigidly fixed to the rest of the mixing head 5 of the machine).

Thus, in the first embodiment of FIGS. 2 to 5, the piston 18 is preferably mobile and the cylinder 17 is fixed, while in the second embodiment of FIG. 7 the cylinder 17 is preferably mobile while the piston 18 is fixed.

FIG. 8 illustrates a third embodiment of an assembly according to the invention. In this embodiment, the chamber 16 comprises an elastically deformable wall 36. The deformation of the elastically deformable wall 36 causes a variation in the volume of the chamber 16. This variation may be caused by a movement of the capsule holder 11 relative to a fixed wall 36 of the chamber 16. This third embodiment may be more complex, as it requires use of a deformable wall which must however sustain the high pressure which is generated in the chamber 16, but obviate any possible sealing issue of the chamber 16.

In all the embodiments of the invention, various actuators may be used to cause the movement that is necessary to cause a variation in the volume of the chamber 16. A manual actuator such as a lever or a manual rotary knob may be used. A cam system or a screw and nut system can be provided for transforming the rotary movement into a translation. The system may provide a gear ratio.

An automatic actuator can be used, with or without a movement transformation system, such as an electric motor, or a piezo electric actuator.

The assembly according to the invention makes it possible to manufacture a machine for food or beverage preparation, where the pumping means are located in a mixing head of the machine. The machine can use existing capsules generally used in machines having a standard design with a pump embedded in the body of the machine. Because high pressure is present only in the assembly according to the invention, standard components designed for low pressure can be used in the rest of the machine. The design of the assembly may so be simplified compared to known machine designs, and the manufacturing cost of the machine can be reduced. Simpler and lighter machines can be obtained.

1. Food or beverage preparation assembly adapted to be embedded in a mixing head of a food or beverage preparation machine, the assembly comprising:
a container holder adapted for receiving a food or beverage precursor ingredient container, the container holder comprising an outlet port,
an inlet port for connecting the assembly to a source of a fluid mixing ingredient; and
the assembly comprises, between its inlet port and the container holder, a chamber having a variable volume, such that an alternating increase and decrease in the volume of the chamber may be provided for pumping mixing ingredient from the source of mixing ingredient to the inlet port of the assembly, and for generating a flow of mixing ingredient through the chamber having a variable volume and through the container holder, such that, when a source of mixing ingredient is connected to the inlet port and a container is received in the container holder, food or beverage product is prepared by mixing the precursor ingredient contained in the container and mixing fluid, and the food or beverage product is expelled through the outlet port.

2. Food or beverage preparation assembly according to claim 1, wherein the chamber is defined in a cylinder between an end wall of the cylinder and the top face of a piston, and wherein the piston may be translated in the cylinder to increase or decrease the volume of the chamber.

3. Food or beverage preparation assembly according to claim 2, wherein the inlet port is located in the cylinder end wall, and the piston is formed by the container holder or rigidly linked to the container holder.

4. Food or beverage preparation assembly according to claim 3, wherein the piston is formed on an upper wall of the container holder.

5. Food or beverage preparation assembly according to claim 2, wherein the inlet port is located in the piston and the cylinder end wall is formed by the container holder.

6. Food or beverage preparation assembly according to claim 2, wherein the cylinder is fixed and the piston is mobile.

7. Food or beverage preparation assembly according to claim 2, wherein the piston is fixed and the cylinder is mobile.

8. Food or beverage preparation assembly according to claim 2, wherein the piston comprises a longitudinal channel through which the fluid mixing ingredient can flow.

9. Food or beverage preparation assembly according to claim 2, wherein the piston comprises a peripheral groove and a seal is installed in the peripheral groove.

10. Food or beverage preparation assembly according to claim 1, wherein the chamber having a variable volume comprises an elastically deformable wall.

11. Food or beverage preparation assembly according to claim 1, wherein the inlet port comprises a one-way valve adapted to let fluid enter the chamber having a variable volume.

12. Food or beverage preparation assembly according to claim 1, wherein the container holder comprises the inlet port which is situated in a central position of a bottom wall of the container holder.

13. Food or beverage preparation assembly according to claim 1, wherein it comprises a mechanical actuator adapted to successively and alternately increase and reduce the volume of the chamber.

14. Food or beverage preparation assembly according to claim 12, wherein the mechanical actuator is selected from the group consisting of an electrically driven motor, a piezo electric actuator, and a manual actuator.

15. Food or beverage preparation machine comprising a mixing head comprising a food or beverage preparation assembly comprising a container holder adapted for receiving a food or beverage precursor ingredient container, the container holder comprising an outlet port, an inlet port for connecting the assembly to a source of a fluid mixing ingredient, and the assembly comprises, between its inlet port and the container holder, a chamber having a variable volume, such that an alternating increase and decrease in the volume of the chamber may be provided for pumping mixing ingredient from the source of mixing ingredient to the inlet port of the assembly, and for generating a flow of mixing ingredient through the chamber having a variable volume and through the container holder, such that, when a source of mixing ingredient is connected to the inlet port and a container is received in the container holder, food or beverage product is prepared by mixing the precursor ingredient contained in the container and mixing fluid, and the food or beverage product is expelled through the outlet port.
